(19) United States
(12) Patent Application Publication
(10) Pub. No.: US 2013/0178237 A1
(43) Pub. Date: Jul. 11, 2013

(54) SMS assisted Call Anchoring to Facilitate the Provision of Advanced Communications Services

(71) Applicant: WEB3TEL INC., Toronto (CA)

(72) Inventors: Konstantin Manyakin, JR., Toronto (CA); Adiel Rozinov, Richmond Hill (CA)

(73) Assignee: WEB3TEL INC., Toronto (CA)

(21) Appl. No.: 13/621,846

(22) Filed: Sep. 18, 2012

Related U.S. Application Data
(60) Provisional application No. 61/536,556, filed on Sep. 19, 2011.

(51) Int. Cl. H04W 76/02

(52) U.S. Cl. CPC H04W 76/02
USPC 455/466

(57) ABSTRACT

A method and system for SMS assisted call establishment to anchor selected cellular calls in a Voice over Internet Protocol (VoIP) or an IP Multi-Media Subsystem (IMS) network employs a mobile handset application client to interrupt selected cellular call initiations and transmit requested destination number and additional information by short message service (SMS) to call control application server. A call placed to the certain call establishment number will be processed by the application server based on information received through SMS, the application server will complete a call connection to the destination number and as a result, the call signalling path through the application server in the VoIP or IMS network will be established to facilitate the provision of advanced call control services. All call establishment steps will be done seamlessly from the prospective of the user of the mobile handset.

### CROSS-REFERENCE TO RELATED APPLICATIONS

This application claims the benefit of Applicants' prior provisional application, No. [61/536,556], filed on [Sep. 19, 2011].

### MICROFICHE APPENDIX

Not Applicable.

### TECHNICAL FIELD OF INVENTION

This application relates in general to providing of enhanced call control and communications services and, in particular, to a method and system for SMS assisted call establishment to anchor selected cellular calls in a Voice over Internet Protocol (VoIP) or an IP Multi-Media Subsystem (IMS) network to facilitate the provision of the enhanced call control features to users of cellular radio devices.

### BACKGROUND OF THE INVENTION

In the context of Mobile Virtual Network Operators (MVNO) it is necessary to provide cost-effective and flexible solution for enabling enhanced call control features. Advanced call control features can be delivered within the context of Voice over Internet Protocol (VoIP). To use these capabilities in mobile network it is necessary to get a control on calls that were originated from the mobile network, in other words it is necessary to anchor these calls.

Known methods of call anchoring have different drawbacks. For example, call anchoring based on calling in to access number and sending destination number as DTMFs can have significant post-dial delay. Another ways of call anchoring require sending information through data network which can be sensitive to the availability and quality of data connection. Other known call-back ways of call anchoring are changing the user pattern of call establishing and also adding additional delay in the process of call establishment.

There therefore exists a need for a method and system that provides fast and cost effective way of calls anchoring which can be done in direct manner without additional post-dial delay and without special requirements to availability of data connection.

While in roaming or establishing a long distance call customer can benefit from moving his originated calls to VOIP network through the call to optimal access number and controlled by message sent to the optimal SMSC gateway.

There therefore exists a need for service providers enable a method and system that can establish a call through VOIP network through optimal gateway and reduce the cost of long distance or roaming subscriber originated cellular calls.

### BRIEF SUMMARY OF THE INVENTION

It is therefore an object of the invention to provide a method and a system for effective call establishment to reduce the cost of roaming and long distance subscriber originated cellular calls and to provide advanced call control features for cellular call launched by subscriber.

The invention therefore provides a method for SMS assisted call establishment to anchor selected cellular calls in a Voice over Internet Protocol (VoIP) or an IP Multi-Media Subsystem (IMS) network, comprising: intercepting all cellular calls launched using the mobile handset; sending a SMS assisting message (SMSAM) containing the called number, location and other information to the call control application server (CCAS) through certain SMSC number; automatically launching a cellular call from the mobile handset to the certain access DN; and completing a call to the called number after the CCAS receives a call request through access DN and correlates it with request information in SMSAM.

The invention further provides a system for SMS assisted call establishment to anchor selected cellular calls initiated by a subscriber from a mobile handset, comprising: a mobile handset application client programmed to: monitor user input to a mobile handset to intercept selected cellular telephone calls launched using the mobile handset; monitor the location of the mobile handset; select SMSC number and access DN based on the location of the mobile handset; send a SMS assisting message (SMSAM) containing the called number, location and other information to the call control application server (CCAS) through certain SMSC number; and launch a cellular telephone call from the mobile cellular handset to certain access DN; and a call control application server (CCAS), comprising a service programmed to: receive a call through certain access DN; if necessary park the call received to certain access DN while waiting for assisting message; receive SMS assisting message from the mobile handset application client; retrieve and verify the subscriber identification and the transformed called number indexed by the calling number and SMSC number; use the transformed called number to formulate a call setup request to the called number; send the call setup request to connect the subscriber to the called number.

The invention further provides a mobile handset application client, comprising: program instructions for monitoring user input to a mobile handset to intercept selected cellular telephone calls launched using the mobile handset; program instructions to monitor the location of the mobile handset; to select SMSC number and access DN based on the location of the mobile handset; program instructions for sending an SMS assisting message (SMSAM) containing the called number, location and other information to the call control application server (CCAS) through certain SMSC number; and program instructions for launching a cellular telephone call from the mobile cellular handset using certain access DN.

The invention yet further provides a call control application server, comprising: a service application that receives the SMSAM request message; extracts location information, subscriber identification, calling number and called number from the SMSAM request message; authenticates this subscriber and applies corresponding dialling policies and phone number transformation rules; stores the transformed called number and the result of authentication indexed by calling number and SMSC number; receives a call through certain access DN; if necessary parks the call received to certain access DN while waiting for assisting message; matches the call with assisting message based on calling number and access DN; uses the transformed called number to formulate a call setup request to the called number; completes the call setup request to connect the subscriber to the called number.

Those skilled in the art will appreciate the scope of the present invention and realize additional aspects thereof after reading the following detailed description in association with the accompanying drawings.

### BRIEF DESCRIPTION OF THE DRAWINGS

The accompanying drawings incorporated in and forming a part of this specification illustrate several aspects of the invention, and together with the description serve to explain the principles of the invention.

FIG. 1 is a block representation of a communication environment according to one embodiment of the disclosure.

FIG. 2 provides an exemplary communication flow according to one embodiment of the disclosure.

FIG. 3 is a block representation of a mobile handset with an application client according to one embodiment of the disclosure.

FIG. 4 is a block representation of a call control application server according to one embodiment of the disclosure.

### DETAILED DESCRIPTION OF THE PREFERRED EMBODIMENT

The embodiments set forth below represent the necessary information to enable those skilled in the art to practice the invention and illustrate the best mode of practicing the invention. Upon reading the following description in light of the accompanying drawings, those skilled in the art will understand the concepts of the invention and will recognize applications of these concepts not particularly addressed herein. It should be understood that these concepts and applications fall within the scope of the disclosure and the accompanying claims.

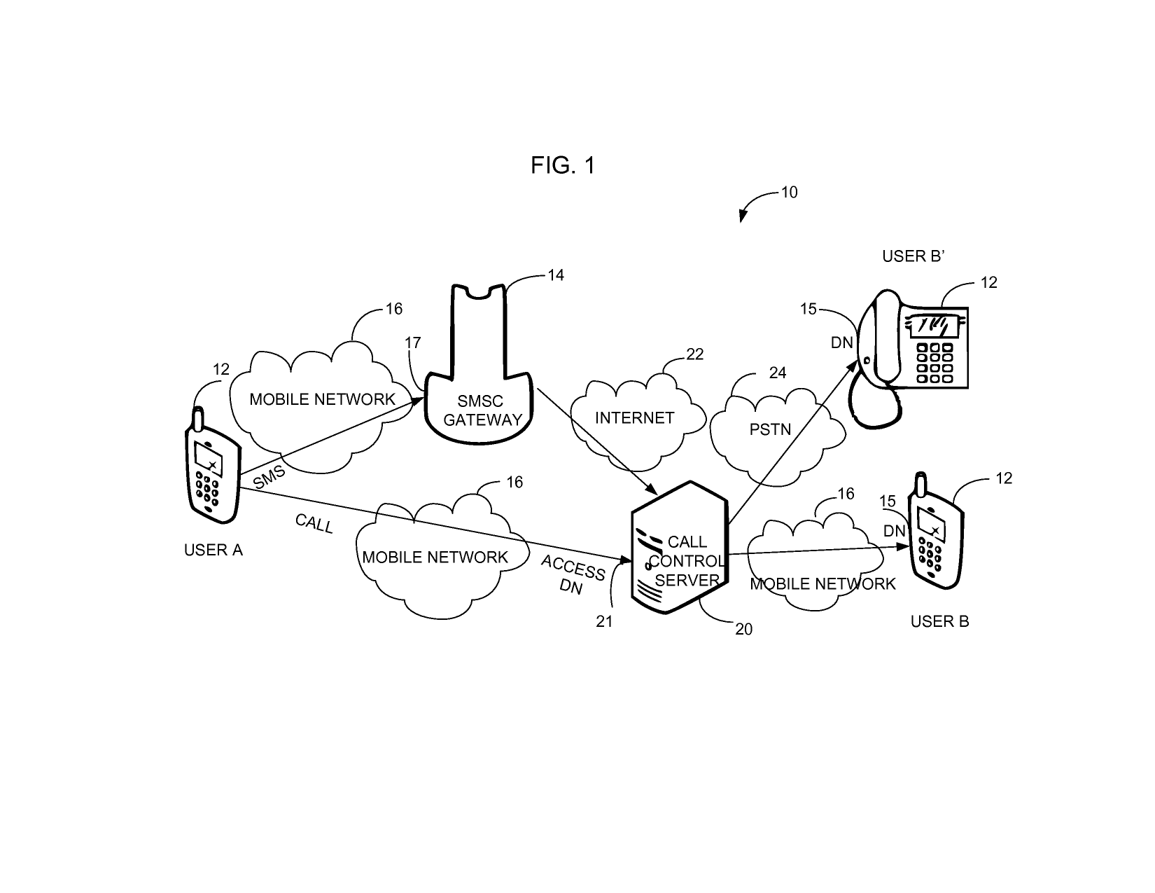

Prior to delving into the details of select embodiments, an overview of an exemplary communication environment 10 is provided in association with FIG. 1. In general, a call control application server (CCAS) 20 is provided to facilitate SMS assisted call establishment between two phones and to anchor selected cellular calls initiated by a subscriber from a mobile handset 12. In an exemplary embodiment, the mobile handset 12 equipped with application client monitors user input to a mobile handset to intercept selected cellular telephone calls and send an SMS assisting message (SMSAM) with information about called number, location and other to SMS gateway 14 through certain SMSC number 17 and at the same time launch a call to the call control application server (CCAS) 20 through certain access DN 21. The call control application server (CCAS) 20 will receive a call through certain access DN 21; if necessary park the call received to certain access DN while waiting for notification from SMS gateway 14 about assisting message; receive notification about SMS assisting message through correspondent communication; retrieve and verify the subscriber identification and the transformed called number indexed by the calling number and SMSC number; use the transformed called number to formulate a call setup request to the called number; send the call setup request to connect the subscriber (user A) to the called number 15 (user B or B′) 12 through packet, mobile network 16 or circuit switched connections 24.

Notably, the devices 12 for user B or B′may take virtually any form, including wired or wireless telephones, personal computers with VOIP application, and the like. The labels provided for these terminals in this description and the following claims are used only to improve readability and separately identify the terminals. Alternatively, the communication device 12 should be a mobile handset (smartphone) with application client which support requested functionality and can communicate through mobile network 16 and send SMS messages.

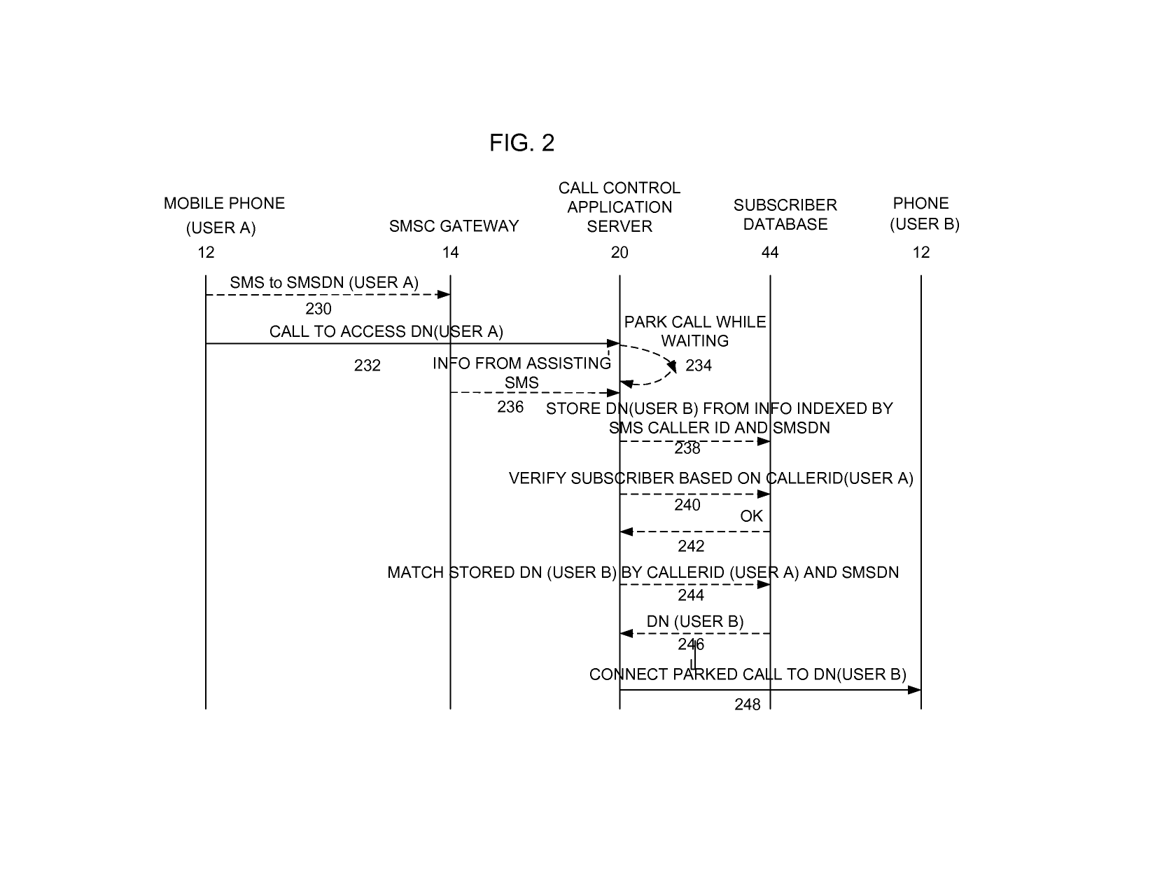

With reference to FIG. 2, a communication flow is provided to illustrate an exemplary scenario for utilizing the call control application server 20 to set up anchored voice call between user A with mobile handset 12 equipped with application client 30 and user B. This is only an exemplary scenario of voice call establishment between two mobile phones, which anchored through application server and can be controlled in future, and the aspects and elements represented in the communication flow are not all deemed necessary for implementation of the present invention. For purposes of clarity, the mobile handset 12 of user A associated with DN A is labelled “Mobile Phone (user A) 12”. Likewise the mobile handset 12 of user B associated with DN B is labelled “Phone (user B) 12”. The SMSC gateway 14 operates to receive assisting SMS messages and provide call related information to the call control application server 20. In accordance with exemplary embodiments, the SMSC gateway 14 is separate from call control server 20 but may be a part of it. The call control application server 20 operates to accept incoming call from users through access DN and process it in accordance with information in assisting SMS message received from the SMS gateway 14. The subscriber database 44 operates to store user profile information, data from assisting SMS message and to provide this information to the service application 40 as requested. In exemplary embodiments, the user database 44 may form a part of the call control application server 20.

At some point, the user A decides to initiate a call from the phone (user A) 12 to the phone (user B) 12 using the number DN B. Specifically, the application client 30 in phone (user A) 12 will intercept this call attempt and send assisting SMS containing the called number DN of user B, location and other information to the call control application server (CCAS) 20 through certain SMSC DN number 17 (step 230) of SMSC gateway 14. At the same time the application client will initiate a cellular telephone call from the mobile cellular handset using certain access DN (step 232).

Next, the SMS gateway 14 receives assisting SMS (SMSAM) request message and extract provided location information, subscriber identification, calling number and called number. This information will be sent to the call control application server (CCAS) 20 to its service application 40 through corresponding communication interface (step 236). In exemplary scenario RESTful API 22 is used as such interface but it can be any type of inter services connectivity.

Now in possession of user A's DN, DN A (calling number), user A's location information and user B/s DN (called number) the call control application server (CCAS) 20 stores this information in the subscriber database 44 (step 238).). In exemplary scenario the call control application server (CCAS) 20 will provide subscriber identification and authentication based on caller ID of incoming assisting SMS message (SMSAM) but other information (for example, location) can be used (step 240, 242). After authentication the call control application server (CCAS) 20 could apply to the called number (DN of User B) corresponding dialing policies and phone number transformation rules and transformed called number plus the result of authentication will be saved in database 44 (step 238) indexed by calling number and SMSC number. In exemplary scenario the inbound call to access DN is coming first (step 230) but it could be when authentication the call control application server(CCAS) 20 is receiving the notification about assisting SMS (SMSAM) first and waiting for receiving incoming call to certain group of access numbers.

The call control application server (CCAS) 20 is receiving an inbound call request at the access DN (step 230), extracting the calling number (user A's DN) and parking the call if the notification about assisting SMS (SMSAM) is not arrived (step 234).

Now in possession of user A's DN, DN A (calling number) from the Caller ID of inbound call at the access DN) the call control application server (CCAS) 20 matches it with the saved information from the assisting SMS and determines whether the extracted calling number corresponds to the calling number in SMSAM request (step 244). If these information matches the call control application server (CCAS) 20 retrieves the transformed called number (user B's DN) to formulate a call setup request to the called number (step 246).

Now in possession of user B's DN, DN B (called number) the call control application server (CCAS) 20 retrieves the initial call leg (if necessary) and sends the call setup request to connect the subscriber to the called number (step 248).

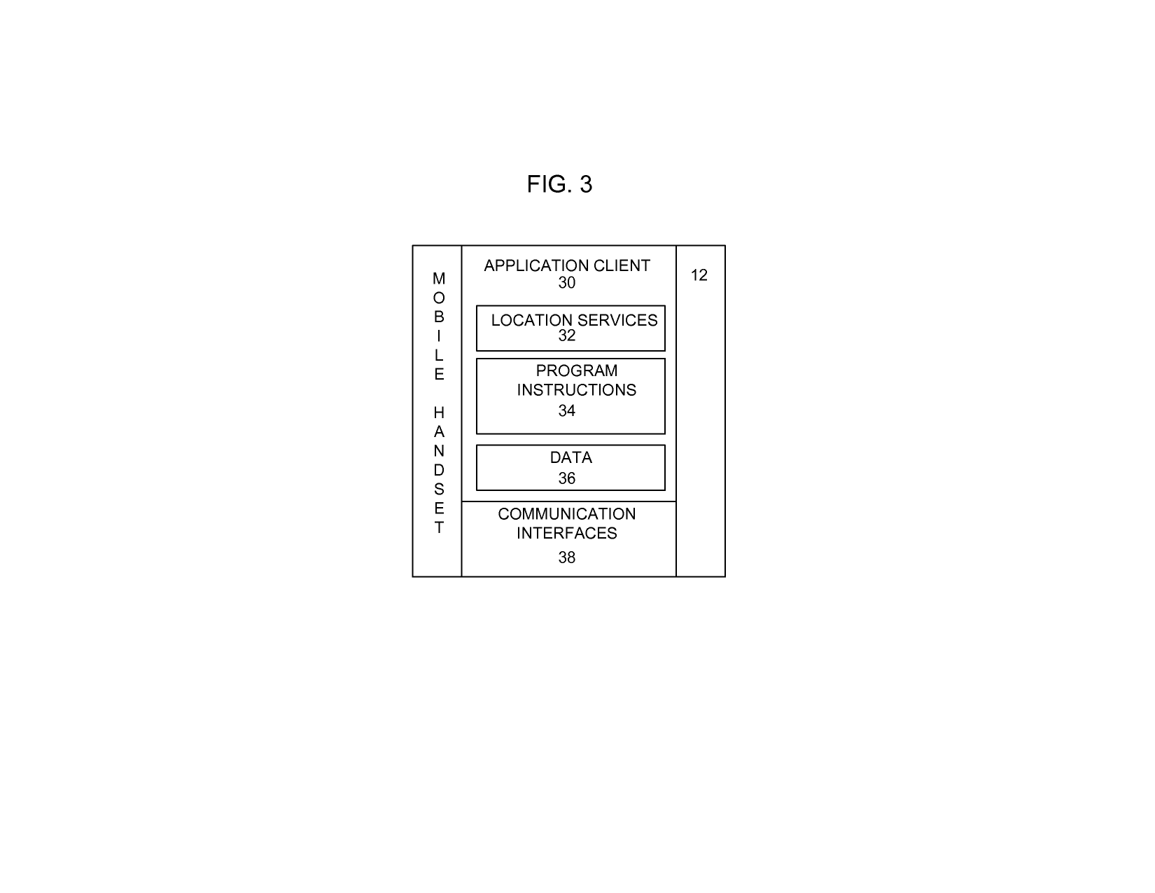

With reference to FIG. 3, a block representation of the mobile handset (smartphone) 12 with an application client 30 is illustrated according to one embodiment. The mobile handset 12 includes an application client 30 having capability of gathering location information from location services 32 and program instructions 34 and data 36 to operate as described above. The program instructions 34 provide the communication functions, data storage and gathering functions and geo location function which are described above. The application client 30 can interact with two communication interfaces 38 (SMS and call setup through mobile network) to provide additional information through SMS assisting message and to establish anchored call through access DN as illustrated in the communication environment 10.

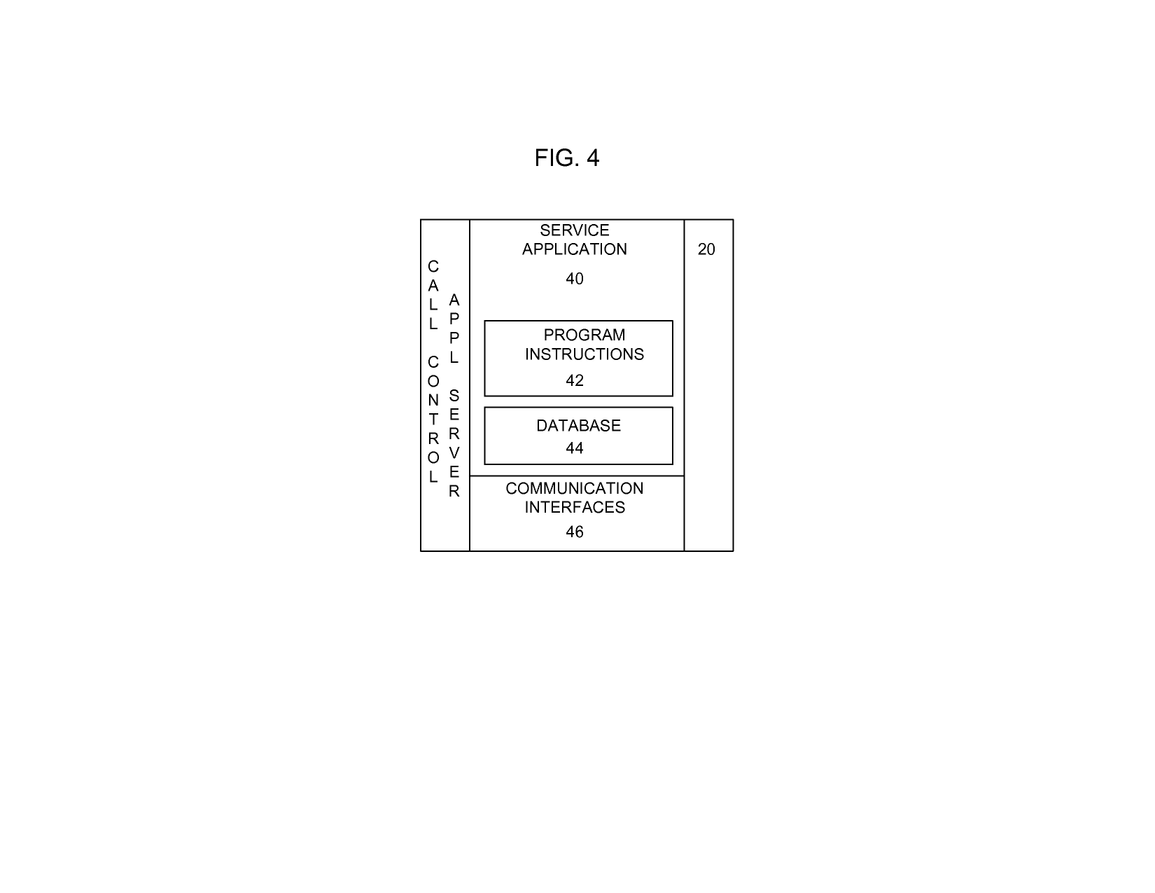

With reference to FIG. 4, a block representation of a call control application server 20 is illustrated. The call control application server 20 includes a service application 40 having capability to store and retrieve subscriber and call specific data in database 44 and program instructions 42 for processing SMS assisting message, accepting and control call requests to access DN and to destination DN as described above. The service application 40 interacts with through several communication interfaces 48 with SMS gateways, PSTN and mobile network to provide call control functionality as described above.

Those skilled in the art will recognize improvements and modifications to the embodiments of the present invention. All such improvements and modifications are considered within the scope of the concepts disclosed herein and the claims that follow.

1. A method for SMS assisted call establishment to anchor selected cellular calls in a Voice over Internet Protocol (VoIP) or an IP Multi-Media Subsystem (IMS) network, comprising: intercepting all cellular calls launched using the mobile handset; sending an SMS assisting message (SMSAM) containing the called number, location and other information to the call control application server (CCAS) through certain SMSC number; automatically launching a cellular call from the mobile handset to the certain access DN; and completing a call to the called number after the CCAS receives a call request through access DN and correlates it with request information in SMSAM.

2. The method as claimed in claim 1 wherein intercepting all cellular calls further comprises examining a called number associated with each cellular call to determine whether the called number is an excluded number.

3. The method as claimed in claim 2 wherein if the called number is an excluded number, the method comprises immediately processing the cellular call to the excluded number using a cellular radio of the mobile handset.

4. The method as claimed in claim 2 wherein determining whether the called number is an excluded number comprises referring to an excluded number list or querying local database to determine whether the called number is in the excluded number list.

5. The method as claimed in claim 1 further comprising collecting location information associated with a current location of the mobile handset and using this information for selecting access DN and local SMSC number by querying local database of access numbers and SMSC numbers.

6. The method as claimed in claim 5 wherein sending the request message comprises formulating a SMSAM request message containing the called number, the location information and an identification of the mobile subscriber and sending the formulated SMSAM request message over a SMS channel of the mobile network to selected SMSC number.

7. The method as claimed in claim 1 further comprising: receiving the SMSAM request message at the CCAS; extracting location information, subscriber identification, calling number and called number from the SMSAM request message; authenticating this subscriber and applying corresponding dialing policies and phone number transformation rules; storing the transformed called number and the result of authentication indexed by calling number and SMSC number and waiting for receiving incoming call to certain group of access numbers.

8. The method as claimed in claim 7 wherein completing the call to the called number comprising: receiving an inbound call request at the CCAS and extracting the calling number; parking the call if SMSAM request is not arrived; determining whether the extracted calling number corresponds to the calling number in SMSAM request; retrieving and verifying the subscriber identification and the transformed called number indexed by the calling number and SMSC number; using the transformed called number to formulate a call setup request to the called number; sending the call setup request to connect the subscriber to the called number.

9. A system for SMS assisted call establishment to anchor selected cellular calls initiated by a subscriber from a mobile handset, comprising: a mobile handset application client programmed to: monitor user input to a mobile handset to intercept selected cellular telephone calls launched using the mobile handset; monitor the location of the mobile handset; select SMSC number and access DN based on the location of the mobile handset; send an SMS assisting message (SMSAM) containing the called number, location and other information to the call control application server (CCAS) through certain SMSC number; and launch a cellular telephone call from the mobile cellular handset to certain access DN; and a call control application server (CCAS), comprising a service programmed to: receive a call through certain access DN; if necessary park the call received to certain access DN while waiting for assisting message; receive SMS assisting message from the mobile handset application client; retrieve and verify the subscriber identification and the transformed called number indexed by the calling number and SMSC number; use the transformed called number to formulate a call setup request to the called number; send the call setup request to connect the subscriber to the called number.

10. A mobile handset application client, comprising: program instructions for monitoring user input to a mobile handset to intercept selected cellular telephone calls launched using the mobile handset; program instructions to monitor the location of the mobile handset; to select SMSC number and access DN based on the location of the mobile handset; program instructions for sending an SMS assisting message (SMSAM) containing the called number, location and other information to the call control application server (CCAS) through certain SMSC number; and program instructions for launching a cellular telephone call from the mobile cellular handset using certain access DN.

11. The application client as claimed in claim 10 further comprising an excluded number list used by the program instructions to determine whether an intercepted call is one of the selected cellular calls.

12. The application client as claimed in claim 10 further comprising program instructions for selecting access DN and SMSC number based on location from the predefined list, which can be configured remotely.

13. A call control application server, comprising: a service application that receives the SMSAM request message; extracts location information, subscriber identification, calling number and called number from the SMSAM request message; authenticates this subscriber and applies corresponding dialling policies and phone number transformation rules; stores the transformed called number and the result of authentication indexed by calling number and SMSC number.

14. The call control application server as claimed in claim 13 further comprising: a service application that receives a call through certain access DN; if necessary parks the call received to certain access DN while waiting for assisting message; matches the call with assisting message based on calling number and access DN; uses the transformed called number to formulate a call setup request to the called number; completes the call setup request to connect the subscriber to the called number.

15. The call control application server as claimed in claim 13 further comprising a database for storing the transformed called number indexed by calling number and SMSC number.
